(19) United States
(12) Patent Application Publication
(10) Pub. No.: US 2026/0039786 A1
(43) Pub. Date: Feb. 5, 2026

(54) SYSTEM AND ASSOCIATED METHODS FOR A DATA HANDLER AND COMMUNICATION DEVICE

(71) Applicant: Sidus Space, Inc., Cape Canaveral, FL (US)

(72) Inventor: Valerij Ojdanic, Indian Harbour Beach, FL (US)

(73) Assignee: Sidus Space, Inc., Cape Canaveral, FL (US)

(21) Appl. No.: 19/291,394

(22) Filed: Aug. 5, 2025

Related U.S. Application Data
(60) Provisional application No. 63/789,978, filed on Jan. 1, 0001.
(60) Provisional application No. 63/679,476, filed on Aug. 5, 2024.

(51) Int. Cl. H04N 17/00; H04L 49/40; H04N 7/18

(52) U.S. Cl. CPC H04N 17/004; H04L 49/405; H04N 7/181

(57) ABSTRACT

A device for data handling and communication may comprise a housing, and a communication hub carried by the housing. The communication hub may include a main controller, a transceiver controller, and a plurality of transceivers. The transceivers may be positioned in communication with the transceiver controller and with hardware devices. The transceiver controller may be operable to control communication between each of the transceivers to selectively route and bridge communication between each of the hardware devices, which may be based on a control signal received from the main controller.

### RELATED APPLICATIONS

This application claims priority under 35 U.S.C. § 119 (e) of U.S. Provisional Patent Application Ser. No. 63/679,476 filed on Aug. 5, 2024 and titled SYSTEM AND ASSOCIATED METHODS FOR A COMMUNICATION DEVICE. This application also claims priority under 35 U.S.C. § 119 (e) of U.S. Provisional Patent Application Ser. No. 63/789,978 filed on Apr. 16, 2025 and titled COMMAND AND DATA HANDLING SYSTEM. The contents of these applications are incorporated herein by reference except to the extent that the content therein conflicts with the content herein.

### FIELD OF THE INVENTION

The present invention relates to systems and methods for data processing and communication devices to command, handle, and communicate data to, from, and between multiple hardware devices.

### BACKGROUND OF THE INVENTION

Many satellites carry multiple sensors and devices—such as still-image cameras, video cameras, and multi-spectral sensors—each paired with its own data-processing module (for example, a frame grabber for video imagery). The cumulative real estate, mass, power, and thermal demands of these discrete processing units become prohibitive as device counts rise. Accordingly, there is a need in the art for a data-processing architecture that interfaces with a plurality of cameras and sensors using fewer hardware modules.

In conventional spacecraft, command and control functions, PNT, and general-purpose computing are implemented as separate components with dedicated power supplies, housings, and wiring harnesses. This modular multiplicity drives up system complexity, extends development and assembly time, and elevates size, weight, and power (SWaP) metrics. Accordingly, there is a need in the art for an integrated command, control, PNT, and computation unit that reduces SWAP and simplifies system integration.

Existing on-board data-handling systems lack built-in intelligence to triage, compress, and prioritize large volumes of sensor data in-situ, such as multi-gigabyte imagery, forcing full-volume downlinks that incur high communication costs, bandwidth constraints, and latency before ground-station access. Accordingly, there is a need in the art for in-situ, AI-based data learning and compression to minimize downlink volume, cost, and latency.

Many current subsystems rely on commercial off-the-shelf components with limited radiation tolerance and temperature resistance. To meet reliability and qualification standards, these subsystems require extensive shielding, redundant circuitry, and separate certification processes for civilian and military applications. Accordingly, there is a need in the art for a ruggedized architecture that is radiation-hardened, temperature-resistant, and compliant with both civilian and military space standards.

Conventional satellite electronics often lack anti-jamming capabilities, error-correcting code (ECC) features, and interoperability with open-architecture frameworks such as the Sensor Open Systems Architecture (SOSA), reducing resilience and complicating cross-platform integration. Accordingly, there is a need in the art for a configurable system that supports anti-jamming, ECC, and SOSA-compatible interfaces.

### SUMMARY OF THE INVENTION

With the above in mind, embodiments of the present invention are related to a device for data handling and communication comprising a housing and a communication hub carried by the housing. The communication hub may include a main controller, a transceiver controller, and a plurality of transceivers. The transceiver controller may be in communication with the main controller. The transceivers may be positioned in communication with the transceiver controller and positionable in communication with hardware devices. The transceiver controller may be operable to control communication between each one of the transceivers to selectively route and bridge communication between each of the respective plurality of hardware devices. The main controller may be operable to generate and send a control signal to the transceiver controller. The transceiver controller may selectively route and bridge communication between each of the hardware devices by controlling communication between the transceivers based on the control signal.

The housing may comprise a radiation hardened housing. The communication hub may be configured to withstand radiation doses that are not greater than 5000 radiation absorbed dose (“rads”). The communication hub may be configured to withstand Single-Event Latchups (“SEL”) that are not greater than 100 MeV*cm2 per milligram, which those skilled in the art will appreciate is a reference to mass stopping power, which is a measure of how much energy a charged particle loses as it travels through a material. The communication hub may have a Single-Event Transient Bit Error Rate (“SET-BER”) of 7×(10\hat{ }(−17)) errors per day. The communication hub may be operable in temperatures between-55 degrees Celsius and +105 degrees Celsius.

The transceiver controller may be operable to selectively route and bridge the communication between the plurality of transceivers to cause the signals transmitted from the respective plurality of hardware devices to be received by at least another one of the respective plurality of hardware devices. The transceiver controller may be operable to selectively route and bridge the communication between the plurality of transceivers to cause signals transmitted from one of the respective plurality of hardware devices to be received by at least two of the respective plurality of hardware devices.

The transceiver controller may be operable to selectively route and bridge the communication between the plurality of transceivers to cause signals transmitted from at least two of the respective plurality of hardware devices to be received by one of the respective plurality of hardware devices. In some embodiments of the present invention, each of the transceivers may include a plurality of communication channels. The communication channels may include receiver communication channels and transmission communication channels.

In some embodiments of the present invention, the housing may comprise a composite 3D printed continuous fused fiber fabrication providing using onyx composite filament. In some embodiments of the present invention, the transceivers may include one or more of a communication port that comprises one or more of a space-grade D-Sub port, an optical communication port, and/or a MIL-spec port. The MIL-spec port may include one or more of a MIL-DTL-38999 port, a MIL-DTL-5015 port, a MIL-DTL-28840 port, a MIL-DTL-24308 (D-Sub) port, and/or a MIL-DTL-83513 (Micro-D) port.

In some embodiments of the present invention, the hardware devices may comprise a plurality of camera devices and at least one framegrabber hardware device that may be in communication with the transceivers. The transceiver controller may control communication between the plurality of transceivers to route and bridge communication between the plurality of camera devices and the at least one framegrabber hardware device. The framegrabber hardware device may be operable to be in communication with more than one camera device of the plurality of camera devices.

The camera devices may generate and emit camera data signals. The transceiver controller may control communication between the transceivers to cause the camera data signals to be received by the framegrabber hardware device(s). The framegrabber hardware device(s) may process the camera data signals to generate and emit processed camera data. The transceiver controller may control communication between the plurality of transceivers to cause the processed camera data signals to be received by the main controller.

In some embodiments of the present invention, each of the transceivers may comprise a plurality of communication channels. The transceiver controller may be operable to cause 50 Ohm high-speed terminations at each of the communication channels. The transceiver controller may be operable to detect loss of signal (“LOS”) at each of the plurality of communication channels. The transceiver controller may comprise a protocol independent crosspoint switch.

### BRIEF DESCRIPTION OF THE DRAWINGS

FIG. 1 is a perspective view of a command and data handing (CDH) device according to an embodiment of the present invention, shown without an outer housing panel to reveal operation units.

FIG. 2 is another perspective view of the CDH device illustrated in FIG. 1, shown with the outer housing panel in a mounted position.

FIG. 3 is a perspective view of an operation unit used in connection with the CSH illustrated in in FIG. 1.

FIG. 4 is a perspective view of the operation unit illustrated in FIG. 3, that is shown mounted on a staging mount of the CDH device illustrated in FIG. 1.

FIG. 5 is a perspective view of multiple operation units mounted to the staging mount of the CDH device illustrated in FIG. 1, shown mounted in a stacked configuration.

FIG. 6 is a schematic diagram of the CDH device illustrated in FIG. 1.

FIG. 7 is a schematic diagram of the CDH device illustrated in FIG. 1 that is illustrated as being carried by an auxiliary system.

FIG. 8 is another schematic diagram of the CDH device carried by the auxiliary system as illustrated in FIG. 7.

FIG. 9 is a schematic diagram of an operation unit of the CDH device according to an embodiment of the present invention.

FIG. 10 is a schematic diagram of another operation unit of the CDH device according to an embodiment of the present invention.

FIG. 11 is a schematic diagram of another operation unit of the CDH device according to an embodiment of the present invention.

FIG. 12 is a schematic diagram of a communication device according to an embodiment of the present invention and being positioned in communication with hardware devices.

FIG. 13 is a schematic diagram of a communications hub of the communication device illustrated in FIG. 12.

FIG. 14 is a perspective view of the communication device illustrated in FIG. 12, shown with a housing.

FIG. 15 is a schematic diagram of a communication hub and a transceiver controller of the communication device illustrated in FIG. 12.

FIGS. 16-20 are schematic diagrams of the communication hub and the transceiver controller of the communication device illustrated in FIG. 12.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a command and data handling device 100, which may alternatively and interchangeably be referred to herein as the CDH device 100 and/or the CDH 100, without limitation. The CDH 100 may be installed, integrated, modulated, adapted, configured, and/or utilized with auxiliary system(s) 400 to command and control the auxiliary system 400 and/or to process and/or handle data from and/or with the auxiliary system 400. Examples of the auxiliary system 400 may include, without limitation, one or more of a weather balloon, a satellite, a space station, a spacecraft, a drone spacecraft, an autonomous craft, a watercraft, a watercraft drone, a submarine, a submarine drone, and aircraft, and aerial drone, a land vehicle, a land-based drone, a stationary monitor and/or detection device, and/or any other data gathering system and/or device which may be self-propelled and/or stationary as may be understood by those who may have skill in the art. For example, the CDH 100 may be installed and/or carried by an auxiliary system 400, and the CDH 100 may act as a necessary controller unit, processor unit, command unit, data handler, data processor, and/or data unit of the auxiliary system 400.

The CDH device 100 may have a 3-U size and/or 3-U openVPX standard form factor, similar and/or the same as a 3-U cube-satellite. The CDH device 100 may be VITA65/OpenVPX and/or SOSA (“Sensor Open Systems Architecture”) compatible and/or compliant. For example, without limitation, embodiments of the CDH device 100 may be configured and/or operable to be compatibly integrated with auxiliary system(s) 400 that may be VITA65/OpenVPX and/or SOSA aligned and/or configured. When and/or while the CDH device 100 is carried by an auxiliary system 400 that comprises a satellite, the CDH device 100 may be configured to operate for about seven or more years in orbit. Each of and/or a significant portion of the CDH device 100 may be configured and/or adapted to be compliant and/or compatible with a class 1 standard under the European Cooperation for Space Standardization (“ECSS Class 1”).

Embodiments of the CDH device 100 may have and/or comply with a Military Standard Level of “S” (“MIL Class Level S”). Embodiments of the present invention may support and/or be capable of running and/or executing any type of operating system, including, and without limitation, VxWorks, Linux, PikeOS, and/or RTEMS. In some embodiments the CDH device 100 may be configured to require a total power consumption that may peak at about 330 watts.

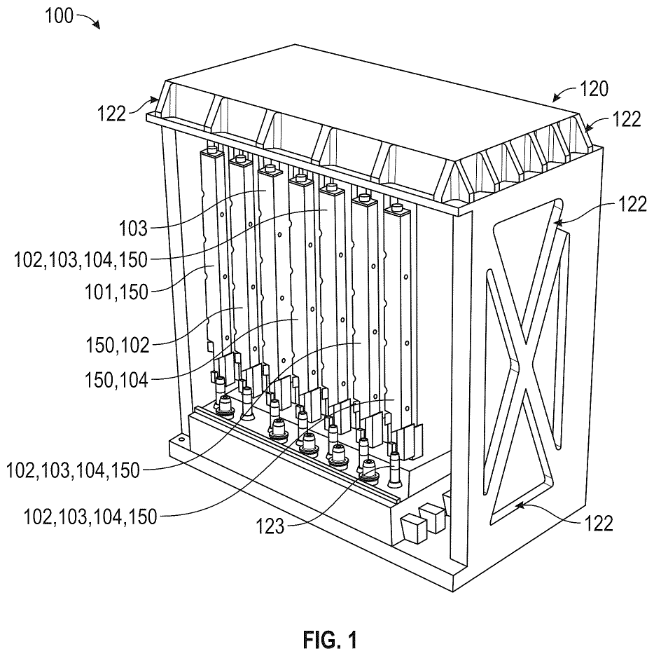

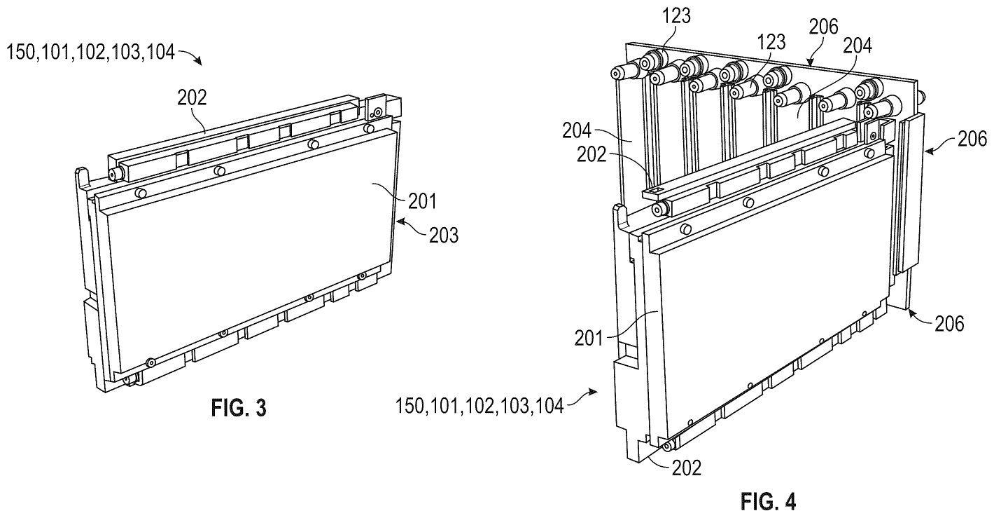

Initially referring to FIG. 1-6, the CDH may include a plurality of operation units 150, which may include one or more of a power unit 101, a position, navigation, and timing unit 102 (PNT unit 102), a computation unit 103, and/or a data unit 104. The operation units 150 may be configured and/or adapted to have an operating temperate between about −55° Celsius to about +125° Celsius. In some embodiments of the present invention, the CDH device 100 may include additional operation units 150, such as, and without limitation, one or more third-party operation units 150.

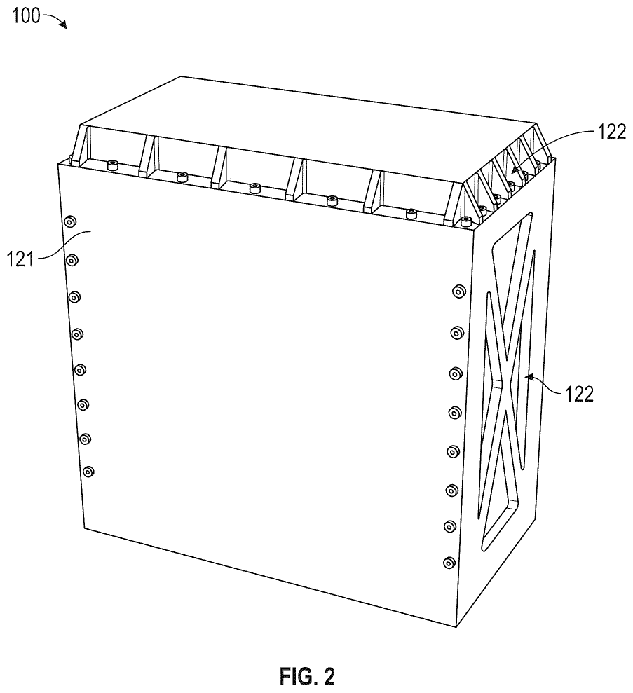

The operation units 150 may be housed and/or carried by an outer housing 120. The outer housing 120 may include one or more housing recesses 122 and/or one or more of a housing panel 121. The housing recesses 122 may provide for a reduced weight of the outer housing 120 in comparison to an embodiment of the outer housing 120 without housing recesses 122. The housing panel 121 may be removably attached to a side portion of the outer housing 120, such that, that housing panel 121 may be movable between a mounted position (shown in FIG. 2) and an unmounted position (shown in FIG. 1).

The outer housing 120 may include one or more attachment members 123 that may be operable to attach the operation units 150 to the outer housing 120 and/or may be operable to attach the outer housing 120 to an auxiliary system 400. The operation units 150 may be mounted to and/or engaged with a staging mount 206 of the outer housing 120. Each operation unit 150 may include a unit housing 201. In some embodiments of the present invention, each unit housing 201 may include one or more of a bumper member 202. The bumper member 202 may be attached to the unit housing 201 and the bumper member 202 may overlay an upper portion and/or a lower portion of the unit housing 201.

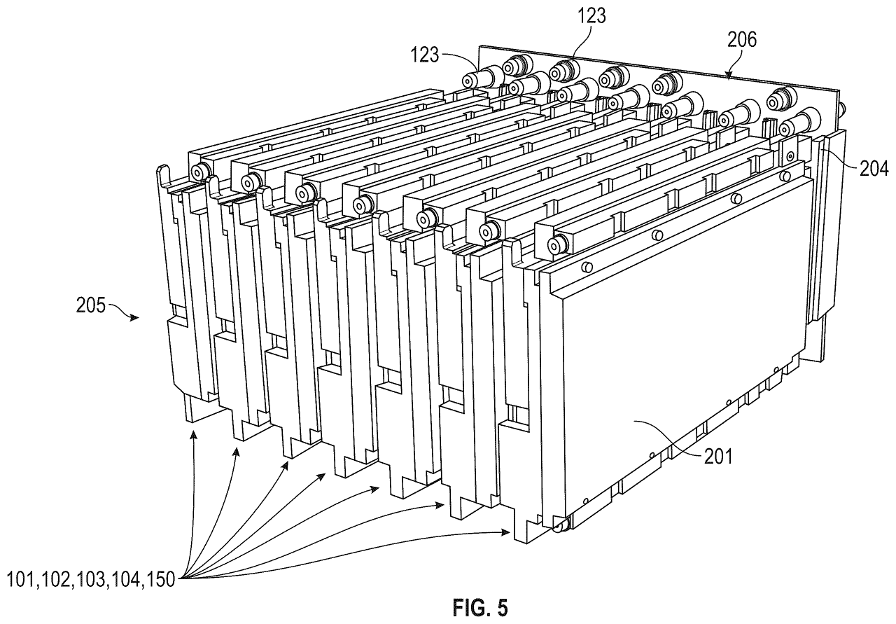

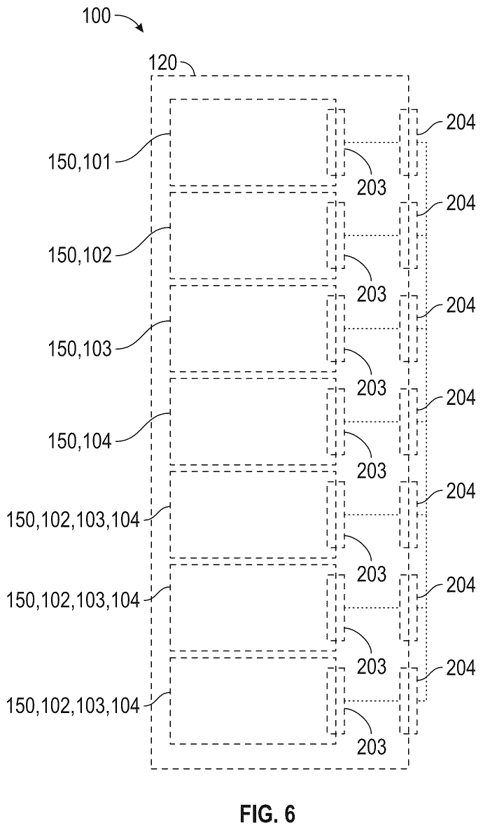

Each operation member 150 may include an engagement member 203. The engagement member 203 may be extending from the operation unit 150 and/or extending from the unit housing 201. The engagement member 203 may be operable to be engaged with and disengaged with a mount member 204 of the outer housing 120 and/or of the staging mount 206. The staging mount 206 may include a plurality of mount members 204. For example, without limitation, the staging mount 206 may include seven mount members 204 as illustratively shown in FIGS. 5-6. While the engagement member 203 of the operation unit 150 is engaged with a mount member 204, the engagement member 203 and the operation unit 150 may be in communication with the mount member 204.

While multiple operation units 150 have their respective engagement members 203 engaged with a respective mount member 204 of the staging mount 206 and/or of the outer housing 120, the operation units 150 may be referred to as being in a stacked configuration 205. While in the stacked configuration 205, the operation unit 150 may have a significantly small amount of space and/or substantially no space in between their respective unit housings 201.

Some embodiments of the CDH 100 may include multiple types of operation units 150. For example, without limitation, the CDH 100 may include one or more of a power unit 101, a position, navigation, and timing unit 102 (PNT unit 102), a computation unit 103, and/or a data unit 104. For another example, without limitation, embodiments of the present invention may include at least one of each of a power unit 101, a PNT unit 102, a computation unit 103, and a data unit 104. For yet another example, without limitation, embodiments of the present invention may include at least one of a power unit 101, a PNT unit 102, a computation unit 103, and a data unit 104 as well as an additional one or more of a power unit 101, a PNT unit 102, a computation unit 103, and/or a data unit 104 as illustratively shown in FIG. 6.

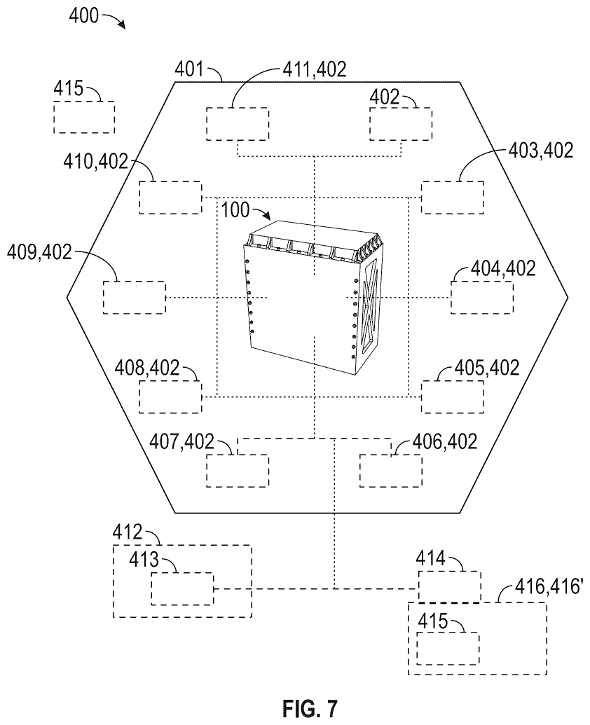

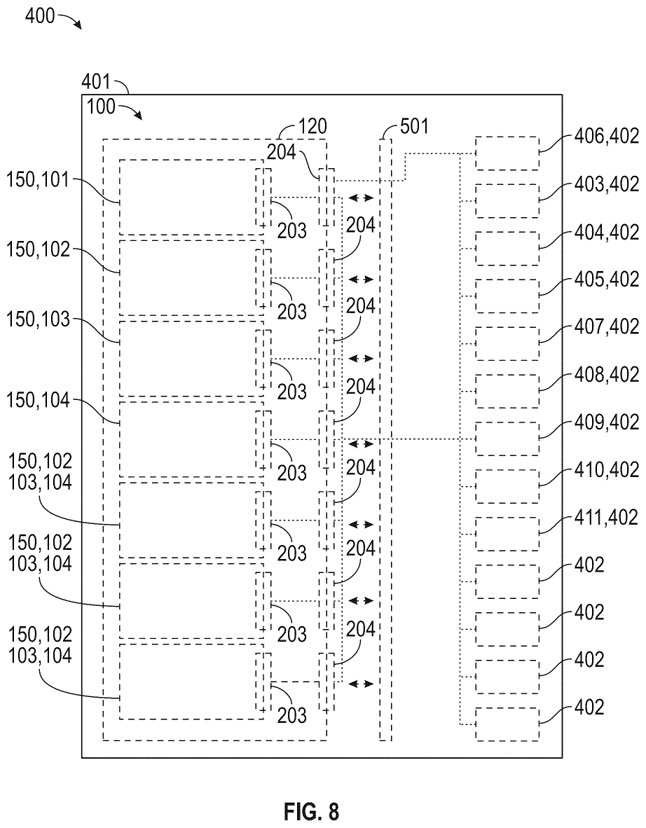

How referring to FIGS. 7-8, the CDH device 100 may be operable to be mounted within and/or carried by an auxiliary system 400 and/or by a body 401 of the auxiliary system 400. Examples of the auxiliary system 400 may include, without limitation, one or more of a satellite system, a spacecraft system, a drone system, an autonomous vehicle system, and/or any deployable and/or controllable device that may be used for data gathering, communications, and/or autonomous operation or substantially autonomous operation and/or any combination(s) thereof. The staging mount 206, mount member(s) 204, and/or engagement members 203 of the CDH device 100 may be mounted on and/or positioned in communication with the auxiliary device 400 while the CDH device 100 is carried and/or housed within the auxiliary system 400. The CDH device 100 and/or the operation members 150 may be operable to be positioned in communication with the auxiliary system 400 via the mount member(s) 204 and/or the staging mount 206 being engaged in communication with a receiver mount 501 of the auxiliary system 400.

The operation members 150 may be positioned in communication with one or more auxiliary components of the auxiliary system 400 while the CDH device 100 is mounted, carried, and/or housed by the auxiliary system 400. For example, without limitation, the auxiliary system 400 may include components, such as, one or more of a payload item 402, which may alternatively and/or interchangeably be referred to as an auxiliary component 408, without limitation. The payload item 402 may comprise one or more devices, systems, and/or apparatuses onboard and/or carried by the auxiliary system 400. For example, without limitation, the payload item may comprise one or more of a computation item 403, a data item 404, a communication item 405, a power item 406, a navigation item 407, an orientation item 409, an optic item 410, a sensor item 411, and/or any other payload item 402/auxiliary component 408 as may be understood by some who may have skill in the art.

Other examples of payload items 402/auxiliary components 408 may include, without limitation, one or more of a material testing system, a device testing system, a detection system, a monitor system, a recorder system, an alternative communication system, an alternative power system, an alternative navigation system and/or any combination(s) thereof as may be understood by those who may have skill in the art. Examples of the computation item 403 include, without limitation, one or more of a controller, a microcontroller, a processor, and/or a field programmable get array. Examples of the data item 404 include, without limitation, one or more of a memory unit, a data storage device, a hard drive, and a solid-state drive. Examples of the communication item 405 include, without limitation, one or more of an antenna, a receiver, a transmitter, and a transceiver. Examples of the power item 406 include, without limitation, one or more of a battery, a solar panel, a power control unit, a power regulator, a power transformer, and a power inverter. Examples of the navigation item 407 include, without limitation, one or more of a global positioning satellite device, a proximity sensor, an altimeter, a horizon detector, a velocity detector, a ground speed detector, and an orientation detector.

Examples of the orientation item 409 include, without limitation, one or more of a gyroscope, a thruster, and a magnetometer. Examples of the optic item 410 may include, without limitation, one or more of an optical sensor, a camera, and an optical image capturing device. Examples of the sensor item 411 include, without limitation, one or more of a light sensor, a temperature sensor, an altitude sensor, an orbital path sensor, an orientation sensor, a radiation sensor, an object detection sensor, and/or any other sensor device as may be understood by those who may have skill in the art. For the purposes of the present description of the present invention, the terms payload item 402 and/or auxiliary component 408 may be used to refer to one or more of the computation item 403, the data item 404, the communication item 405, the power item 406, the navigation item 407, the orientation item 409, the optic item 410, and/or the sensor item 411 either individually, in combination, and/or in any combination thereof without any limitation and as may be understood by those who may have skill in the art.

The CDH device 100 and/or the operation members 150 may be operable to be positioned in communication with the auxiliary system 400 and/or one or more of the payload items 402 when and/or while the mount member(s) 204 and/or the staging mount 206 is engaged in communication with a receiver mount 501 of the auxiliary system 400, which may be referred to as the CDH device 100 and/or the operation member(s) 150 being in the engaged position, the mounted position, and/or the carried position. While in the engaged position, one or more of the operation members 150 may be in communication with one or more of the payload members 402 of the auxiliary system 400, and one or more of the operation members 150 may be adapted and/or configured to command, control, operate, and/or co-operate with one or more of the payload members 402 of the auxiliary system 400.

In some embodiments of the present invention, the CDH device 100, one or more of the operation member 150, and/or the PNT unit 102 may be operable to be in communication with one or more of another auxiliary system 412, which may be when and while the CDH device 100 is in the engaged position, and/or which may be via a payload item 402 and/or via communication item 405 of the auxiliary system 400. The other auxiliary system 412 may alternatively and/or interchangeably be referred to herein, without limitation, as a second auxiliary system 412. In some embodiments of the present invention, the second auxiliary system 412 may also include and/or carry another CDH device 413. The other CDH device 413 carried by the second auxiliary system 412 may alternatively and/or interchangeably be referred to herein, without limitation, as a second CDH device 413. The second CDH device 413 may include the same and/or components, features, and/or advantageous as one or more of the embodiments of the CDH device 100 as described herein, without limitation.

In some embodiments of the present invention, the CDH device 100 may be operable to be in the engaged position with an auxiliary system 400 that may include a plurality of payload items 402 which may be carried by the auxiliary system 400 and/or carried by the body 401 of the auxiliary system 400. The payload items 402 may be in communication with a receiver mount 501 of the auxiliary system 400. While the CDH device 100 and/or operation units 150 are in the engaged position, the operation units 150 may be positioned in communication with one or more of the payload items 402 via the engagement members 203, the staging mount 206, and/or the receiver mount 501.

While in the engaged position, the power unit 101 may be in communication with a payload item 402 that may comprise a power item 406. The power unit 101 may receive power from the power item 406, and the power unit 101 may provide, control, regulate, and transmit power from the power received to one or more of the other operation units 150. In some embodiments of the present invention, the power unit 101 may be configured to provide about 28 volts in direct current at about 12 amperes and may provide a maximum power of about 330 watts. Max Power Each of the operation units 150 may be in communication with one another, and/or the each of the operation units 150 may be in communication with at least another one of the other operation units 150.

Now referring to FIGS. 6-9, the PNT unit 102 operation unit 150 may be in communication with one or more of the payload items 402 and/or auxiliary components 408 while in the engaged position. The PNT unit 102 may also be operable to be in communication with one or more communication device(s) 414 and/or object(s) 415, which may include, without limitation, one or more of another CDH device 100, a ground station, a satellite, a drone, an authorized user device, and/or a terminal and/or any combination(s) thereof and any other communication device 414 as may be understood by those who may have skill in the art. The PNT unit 102 may be operable, configured, and/or adapted to determine the location, speed, direction of travel, and current time of the PNT unit 102, the CDH device 100, and/or the respective auxiliary system 400 the PNT unit 102 and/or CDH device 100 is in the engaged position therewith. The PNT unit 102 may be operable, configured, and/or adapted to determine the location speed, direction of travel, and/or current time based on one or more signals that may be received by the PNT unit 102.

The PNT unit 102 may include a printed circuit board 901 (“PCB” 901) and one or more operational components. For example, without limitation, the PNT unit 102 may include an atomic clock 902, a receiver 907, an antenna power component 908, a crystal oscillator 910, a fanout buffer 911, an inertial measurement unit 913 (“IMU” 913), a clock synthesizer 916, a first memory 918, a second memory 919, a third memory 920, a fourth memory 921, a fifth memory 922, a sixth memory 923, power and temperature sensors 924, a controller 925, a bootloader and diagnostic tester 926, a field programmable gate array 927, a processing member 935, and/or one or more logic members 917.

The PCB 901 may facilitate and/or allow communication between each of the operational components of the PNT unit 102. The engagement member 203 of the PNT unit 102 may comprise one or more of a first port 904, a second port 905, and a third port 906. Each of the first port 904, second port 905, and the third port 906 may be carried by and in communication with the PCB 901.

The atomic clock 902 may be carried by the PCB 901, and the atomic clock 902 may be in communication with one or more of the PCB 901, the fanout buffer 911, the processing member 935, and one or more of the logic members 917. The atomic clock 902 may be in communication with one or more of the receiver 907, the crystal oscillator 910, the engagement member 203, and/or the third port 906 via one of the logic member(s) 917. The atomic clock 902 may be operable to keep time by counting oscillations of resonance frequencies of one or more atoms carried by the atomic clock 902. The atomic clock 902 may generate and/or emit an atomic clock signal based on the counted oscillations of resonance frequencies of one or more atoms carried by the atomic clock 902. The atomic clock 902 may comprise, without limitation, one or more of a rubidium atomic clock. The atomic clock 902 may have less than 3E-10 ADEV at 1 second. The atomic lock 902 may be adapted to have a max frequency change due to temperature that is about +/−3.0 E-10. The atomic clock 902 may be configured and/or adapted to be radiation tolerant to CSAC. Further, the atomic clock 902 may comprise a low-noise atomic clock.

In some embodiments of the present invention, one of the logic members 917 may be in communication with one or more of the crystal oscillator 910, the atomic clock 902, the engagement member 203, the third port 906 and/or the second port 905. The crystal oscillator 910 may be operable to generate and emit a crystal oscillator signal based on the oscillations of a crystal material carried by the crystal oscillator 910. The crystal oscillator 910 may comprise, without limitation, a 120 mega-Hertz oven-controlled crystal oscillator (“OCXO”) and/or a 125 mega-Hertz OCXO.

The logic member 917 may be operable to generate and/or emit a reference clock signal based on the atomic clock signal and/or the crystal oscillator signal. The reference clock signal from the logic member 917 may be sent to and/or received by the receiver 907. The reference clock signal from the logic member 917 may also and/or alternatively be sent to and received by the engagement member 203, the third port 906 and/or the second port 905 to be received by one or more of the payload items 402 and/or auxiliary components 408 of an auxiliary system 400 engaged with the PNT unit 102.

The receiver 907 may be carried by the PCB 901, and the receiver 907 may be in communication with one or more of the antenna power component 908, the processing member 935, the engagement member 203, the third port 906, and/or one or more of the logic member(s) 917. The receiver 907 may be in communication with one or more of the atomic clock 902, the fanout buffer 911, the crystal oscillator 910, the engagement member 203, and/or the third port 906 via one or more of the logic members 917.

The receiver 907 may comprise, without limitation, one or more of a global navigation satellite system (GNSS) device and/or a global positioning system (GPS) device. In some embodiments of the present invention, the receiver 907 may be configured and/or operable to utilize software defined radio that may be S Band and/or X Band. The receiver 907 may be configured to provide satellite constellation tracking. The receiver 907 may be configured to read, generate, write, emit, receive, send, and/or use L1C/A (Legacy Civil/Access), L1C (Modernized Civil Signal), L2C (Second Civil Signal), and L5 (Safety-of-Life Signal) (including WAAS (Wide Area Augmentation System), EGNOS (European Geostationary Navigation Overlay Service), and SDCM (System for Differential Correction and Monitoring). Further, the receiver 907 may be configured to read, generate, write, emit, receive, send, and/or use BeiDou: B1 (Frequency Band 1) and B2 (Frequency Band 2), GLONASS: L1OF (Standard Precision Signal in the L1 Band), L2OF (Standard Precision Signal in the L2 Band), and CDM (Code Division Multiplexing), Galileo: E1 (Open Service Signal in the E1 Band), E5A (Safety-of-Life Service Signal in the E5a Band), and E5B (Safety-of-Life Service Signal in the E5b Band).

The receiver 907 may be operable to be in communication with one or more of the auxiliary components 408 and/or payload items 402 via the antenna power component 908 and/or via one of the logic members 917. In some embodiments of the present invention, the receiver 907 may be configured to receive power, which may be referred to as antenna power, from one or more of the antenna power component 908 and/or from an auxiliary system 400 via the engagement member 203 and/or the third port 906.

The receiver 907 may be in communication with the processing member 935. The receiver 907 may be operable to be commanded and controlled by the processing member. The receiver 907 may be operable to be in communication with one or more of a second auxiliary system 412 and/or a second CDH system 413 of a second auxiliary system 412, which may comprise communication via a communication item 405 carried by the auxiliary system 400. The receiver 907 may be operable to generate, send, and/or receive one or more signals via one or more communication lines 909, 912, 914, 915, 932, 933.

The signals generated, sent, and/or received by the receiver 907 may comprise a global positioning system and/or global navigation satellite system signal (hereinafter referred to as a “navigation signal”) as may be understood by those who may have skill in the art. The navigation signal may be sent and/or received by the receiver 907 via a navigation signal line 912 and/or a communication signal line 932. The signals generated, sent, and/or received by the receiver 907 may further comprise one or more of a reference clock signal, a fanout input signal, a fanout output signal, an enable signal, and/or a host communication signal, which may be sent and/or received by the receiver 907 via one or more of the communication lines 932, reference clock signal line 909, navigation input line 912, fanout input line 915, fanout output line 914, and/or host communication line 933.

The receiver 907 may be operable to determine a position, vector, velocity, speed, altitude, and/or time based on one or more of the reference clock signal, the fanout input signal, the fanout output signal, the enable signal, and/or the host communication signal. The receiver 907 may be operable and/or configured to generate, provide, and/or emit a navigation determination signal that may include the determination of one or more of position, vector, velocity, speed, altitude, and/or time by the receiver 907 based on one or more of the reference clock signal, the fanout input signal, the fanout output signal, the enable signal, and/or the host communication signal. In some embodiments of the present invention, the receiver 907 may be operable to determine position, vector, velocity, speed, altitude, and/or time by the receiver 907 based on one or more of the reference clock signal, the fanout input signal, the fanout output signal, the enable signal, and/or the host communication signal by using trilateration.

Some embodiments of the present invention may include an antenna power component 908. The antenna power component 908 may be carried by and/or in communication with the PCB 901, and the antenna power component 908 may be in communication with one or more of the receiver 907, the third port 906, and/or the engagement member 203. The antenna power component 908 may be operable to provide power to an antenna (not shown), as may be understood by those who may have skill in the art, which may be carried by one or more of the PCB 901, the outer housing 120, the unit housing(s) 201, and/or by the auxiliary system 400. In some embodiments of the present invention, one of the auxiliary components 408 and/or payload items 402 may comprise the antenna.

Some embodiments of the present invention may include a crystal oscillator 910 carried by and/or in communication with the PCB 901. The crystal oscillator 910 may be in communication with one or more of the logic members 917 and/or the receiver 907. The crystal oscillator 910 may be operable and/or configured to generate, emit, and/or provide a crystal timing signal that may at least partially be used by one of the logic members 917 to define the reference clock signal.

In some embodiments of the present invention, one or more of the logic devices 917 may receive an auxiliary clock signal via an auxiliary clock communication line 903 and/or one of the communication lines 932. One or more of the logic members 917 may be operable to determine, generate, provide, and/or emit a clock comparison signal based on the auxiliary clock signal and/or the fanout output signal.

Embodiments of the PNT unit 102 may include a fanout buffer 911. The fanout buffer 911 may be carried by and in communication with the PCB 901, and the fanout buffer 911 may be operable to distribute a signal fanned-out signal to multiple devices to ensure that the same fanned-out signal is received by the multiple devices while also maintaining the integrity of any fanned-out signal, as may be understood by those who may have skill in the art.

The PNT unit 102 may include an inertial measurement unit 913 (“IMU” 913), the IMU 913 may be carried by, and in communication with, the PCB 901. The IMU 913 may be operable to track, detect, determine, and/or sense inertia forces on the IMU 913 and/or the CDH device 100. The IMU 913 may be operable to determine a speed, vector, inertia force, position, orientation, and/or heading based on the inertia force(s) tracked, detected, determined, and/or sensed. The IMU 913 may be operable to generate, send, and/or emit an IMU signal based on the inertia force(s) tracked, detected, determined, and/or sensed by the IMU 913. The IMU 913 may have a Gyro Bias Instability of about 0.8° per hour, an Angular Random Walk of about 0.03 per hour, an Initial Bias Error of about 360°/hour (1σ)/2 mG (1σ). In some embodiments of the present invention, the IMU 913 may include one or more and/or triple Gyroscopes that may be configured to provide +/−200° per second. Further, the IMU 913 may include a tri-Axis Accelerometer that may be adapted to support +/−10 Gravitational-forces.

Some of those who may have skill in the art may notice and appreciate that the IMU 913 may allow for the CDH device 100 to determine and/or cross-reference the speed, vector, inertia force, position, orientation, and/or heading of the CDH device 100 without and/or in reference to the speed, vector, inertia force, position, orientation, and/or heading determined by the receiver 907, for example, without limitation, if when and/or while the receiver 907 is unable to receive signals from or send to communication device(s) 414, which may happen, without limitation, when and/or while the signals to and/or from the PNT unit 102 are being distorted, corrupted, jammed, obstructed, interfered, intercepted, attenuated, and/or blocked.

In some embodiments of the present invention, the PNT unit 102 may include a clock synthesizer 916 that may be carried by and in communication with the PCB 901. The clock synthesizer 916 may be operable and/or utilized to generate synthesized clock signals at specific frequencies. The synthesized clock signals generated by the clock synthesizer 916 may be based upon reference clock signal(s) that may be received by the clock synthesizer 916. The synthesized clock signals may be utilized as the timing signal and/or timing reference for one or more of the other components and/or devices of the PNT unit 102 and/or the CDH device 100.

Embodiments of the PNT unit 102 may include one or more memory components. For example, and without limitation, the PNT unit 102 may include one or more of a first memory 918, a second memory 919, a third memory 920, a fourth memory 921, a fifth memory 922, and/or a sixth memory 923. The memory unit(s) 918, 919, 920, 921, 922, 923 may be operable to store, manage, and/or provide data stored therein. The memory unit(s) 918, 919, 920, 921, 922, 923 may comprise one or more types of memory, such as, and without limitation, flash memory, NAND memory, NOR memory, non-volatile computer-readable memory, volatile computer-readable memory, and/or random-access memory (RAM) and/or any combination(s) thereof and any other memory device as may be understood by those who may have skill in the art.

In some embodiments of the present invention, the PNT unit 102 may include one or more power and temperature sensors 924. The power and temperature sensors 924 may be operable to detect, sense, determine, monitor, and/or track a power level and/or temperature level of the power and temperature sensors 924 and/or of one or more portions of the PNT unit 102 and/or PCB 901. The power and temperature sensors 924 may be operable to provide a power and/or temperature signal to a controller 925 of the PNT unit 102.

The controller 925 may be carried by and/or in communication with the PCB 901. The controller 925 may be operable to control, manage, command, operate, monitor, and/or oversee one or more of the components of the PNT unit 102 and/or of an auxiliary system 400 that may be in communication with the PNT unit 102 and/or with the controller 925. For example, and without limitation, the controller 925 may be operable to control, manage, command, operate, monitor, and/or oversee one or more of the auxiliary components 408 and/or payload items 402 of an auxiliary system 400. An example of the controller 925 includes, but without limitation, a microcontroller.

The PNT unit 102 may further include one or more of a bootloader and diagnostic tester 926. The bootloader and diagnostic tester 926 may be carried by and/or in communication with the PCB 901. The bootloader and diagnostic tester 926 may be operable to boot-load the operation(s) and/or perform diagnostic testing of the PNT unit 102 and/or of one or more portions and/or operations of the PNT unit 102 as may be understood by those who may have skill in the art.

The PNT unit 102 may also include one or more of a field programmable gate array 927 (“FPGA” 927). The FPGA 927 may be reprogrammable and/or may be operable to provide parallel processing capabilities. The FPGA 927 may be operable to cooperate with one or more of the controller 925 and/or a processing member 935 of the PNT unit 102 to allow for compatibility and selective modularization of the PNT unit 102 that may further allow for the PNT unit 102 to control, manage, command, operate, monitor, and/or oversee one or more of the auxiliary components 408 and/or payload items 402 of an auxiliary system 400. For example, and without limitation, the FPGA 927 may be reprogrammed by the processing member 935 of the PNT unit 102 based on FPGA programming signals received by the PNT unit 102 from an external source, which may include an external source comprising a communication device 414 as illustratively shown in FIG. 7.

Examples of the communication device 414, includes, and without limitation, a base station, ground station, remote device, and/or authorized user device. Examples of the processing member 935 include, without limitation, one or more of a central processing unit, a microprocessor, a co-processor, a microcontroller, a field-programmable gate array, and/or an application specific integrated circuit and/or any combination(s) thereof.

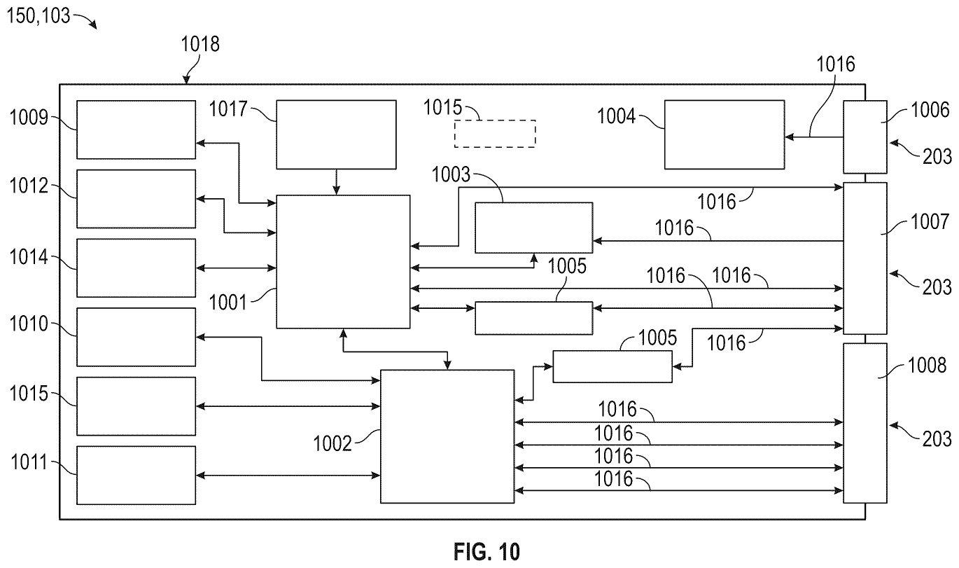

Now referring to FIGS. 6-8 and 10, the computation unit 103 may be in communication with one or more of an auxiliary system 400, auxiliary components 408, and/or payload items 402 while the computation unit 103 and/or CDH device 100 is in the engaged position. The computation unit 103 may be operable and/or configured to manage, control, monitor, command, and/or operate one or more of other portions(s) of the computation unit 103, portion(s) of the CDH device 100, the auxiliary system 400, one or more of the auxiliary components 408 and/or payload items 402 and/or any combination(s) thereof. The computation unit 103 may be operable to read, write, interpret, compute, process, send, receive, translate, and/or generate machine-readable instructions, code, language, commands, programs, executables, and/or data. The computation unit 103 may also be operable to store and/or provide machine-readable instructions, code, language, commands, programs, executables, and/or data.

The computation unit 103 may include one or more of a PCB 1018, memory components, a processing member 1001, an FPGA 1002, a communication member 1003, a power member 1004, a logic member 1005, communication line(s) 1016, and/or clock member 1017 and/or any combination thereof without limitation. The PCB 1018 may be configured to carry, be in communication with, and/or facilitate communication between one or more other components of the computation unit 103. For example, without limitation, the PCB 1018 may carry, and be in and facilitate communication between one or more of the memory components, the processing member 1001, the FPGA 1002, the communication member 1003, the power member 1004, the logic member 1005, and/or the clock member 1017 and/or any combination thereof. The communication line(s) 1016 may facilitate communication between one or more of the components of the computation unit 103.

The engagement member 203 of the computation unit 103 may comprise one or more ports, such as, and without limitation, a first port 1006, a second port 1007, and/or a third port 1008. Each of the ports 1006, 1007, 1008 may be carried by and/or in communication with the PCB 1018. Each of the ports 1006, 1007, 1008 may be configured and/or operable to be positioned in communication with an auxiliary system 400 when the CDH device 100 and/or computation unit 103 is in the engaged position.

The ports 1006, 1007, 1008 may be in communication with one or more of the computation unit 103 components carried by the PCB 1018, and the ports 1006, 1007, 1008 may be positioned in communication with one or more auxiliary components 408 and/or payload items 402 while the CDH device 100 and/or computation unit 103 is in the engaged position with an auxiliary system 400. Each of the ports 1006, 1007, 1008 may be operable to allow and/or facilitate communication between one or more of the components of the computation unit 103 carried by the PCB 1018 and one or more of the auxiliary components 408 and/or payload items 402 while the computation unit 103 is in the engaged position.

The memory components of the computation unit 103 may comprise, without limitation, one or more of a processing memory 1009, an FPGA memory 1010, a flash memory 1011, a volatile memory 1014, a first peripheral interface 1012, and/or a second peripheral interface 1013 and/or any combination(s) thereof. The memory components 1009, 1010, 1011, 1012, 1013, 1014 of the computation unit 103 may comprise, without limitation, one or more of a random-access memory, a double-data rate 1-5 (DDR1-DDR5) synchronous dynamic random-access memory, a volatile machine-readable memory, a non-volatile machine-readable memory, a virtual memory, a data storage device, a cache memory, a solid state drive, a flash memory, a NAND memory, a NOR memory, a quad-serial peripheral interface, and/or any combination(s) thereof as may be understood by those who may have skill in the art. The memory components 1009, 1010, 1011, 1012, 1013, 1014 may be carried by the PCB 1018 and may be in communication with one or more of the processing memory 1001, and/or the FPGA 1002.

The first peripheral interface 1012 and/or the second peripheral interface 1013 may comprise quad-serial peripheral interface(s) and may be operable to enable data transfer between flash memory portion(s) of the memory components of the computation unit 103 and the processing member 1001 and/or between the flash memory portion(s) of the computation unit 103 and the FPGA 1002. The first peripheral interface 1012 and/or the second peripheral interface 1013 may store firmware, bootloaders, and/or other software components of the computation unit 103.

The clock member 1017 of the computation unit 103 may be carried by and in communication with the PCB 1018. The clock member 1017 may be in communication with the processing member 1001, and the communication between the clock member 1017 and the processing member 1001 may be via the PCB 1018. The clock member 1017 may be operable to read and/or track a time, and the clock member 1017 may be operable to generate a clock signal and send and/or emit the generated clock signal to the processing member 1001. Examples of the clock member 1017 include, without limitation, one or more of a real-time clock device as may be understood by those who may have skill in the art.

The processing member 1001 may be carried by and in communication with the PCB 1018. The processing member 1001 may also be in communication with one or more of the memory components of the computation unit 103, which may include, without limitation, the processing member 1001 being in communication with one or more of the processing member 1009, the first peripheral interface 1012, and/or the volatile memory 1014. The processing member 1001 may also be in communication with one or more of the FPGA 102, the engagement member 203, the second port 1007, the communication member 103, and/or the logic member 1005. The processing member 1001 may be operable and/or configured to command, control, manage, monitor, and/or operate one or more of the other components of the computation unit 103, including, and without limitation, one or more of the FPGA 1002, the communication member 1003, the power member 1004, the logic member 1005, the processing member 1009, the first peripheral interface 1012, and/or the volatile memory 1014 and/or any combinations thereof.

In some embodiments of the present invention, the processing member 1001 may be in communication with one or more of an auxiliary system 400 that the computation unit 103 may be in the engaged position therewith, one or more auxiliary components 408 and/or payload items 402 of the auxiliary system 400, and/or one or more of any other operation units 150 of the CDH device 100 that may be engaged with the staging mount 206. The processing member 1001 may be operable to read, write, computer, process, execute, send, receive, store, direct, manipulate, run, delete, translate, and/or interpret machine-readable code, language, data, instructions, executables, programs, commands, and/or applications. Examples of the processing member 1001 include, without limitation, one or more of a central processing unit, a co-processor, a microprocessor, a microcontroller, a field-programmable gate array, an application specific integrated circuit, and/or a processor and/or any combination(s) thereof as may be understood by those who may have skill in the art.

The FPGA 1002 may be carried by and in communication with the PCB 1018. The FPGA 1002 may also be in communication with one or more of the processing member 1001, the transceiver(s) 1005, the engagement member 203, the third port 1008, the flash memory 1011, the second peripheral interface 1013, and/or the FPGA memory 1010. The FPGA 1002 may be operable and/or configured to be reprogrammable and/or configured to provide parallel processing capabilities. The FPGA 1002, similar to other FPGA's discussed herein, may be operable be reprogrammed, without limitation, when and/or while the FPGA 1002 and/or computation unit 103 is engaged with an auxiliary system 400. The FPGA 1002 may be reprogrammed based on and/or responsive to reprogram signals that may be received by the computation unit 103 from one or more of a communication device 414 and/or object 415.

The communication member 1003 may be carried by and in communication with the PCB 1018. The communication member 1003 may also be in communication with one or more of the processing member 1001, the engagement member 203 of the computation unit 103, and/or the second port 1007. The communication member 1003 may be operable to be in communication with a network and/or to send and/or receive data via wired and/or wireless communications. The communication member 1003 may include a physical layer transceiver and/or magnetics as may be understood by those who may have skill in the art.

The power member 1004 may be carried by and in communication with the PCB 1018 and one or more of the other components of the computation unit 103. The power member 1004 may be configured and/or adapted to provide, regulate, manage, monitor, and/or control electrical power to one or more of the other components of an embodiment of the computation unit 103. Examples of the power member 1004 include, without limitation, one or more of the power regulator, a voltage regulator, an amperage regulator, a transformer, an inverter, a rectifier, and/or any combination(s) thereof and any other power providing and/or regulating device that may be utilized as the power member 1004 described herein as may be understood by those who may have skill in the art.

Embodiments of the computation unit 103 may include one or more of a logic member 1005. The logic member(s) 1005 may be carried by and in communication with the PCB 1018. One or more of the logic member(s) 1005 may be in communication with the processing member 1001 and the engagement member 203 and/or the second port 1007, and/or one or more of the logic member(s) 1005 may be in communication with the FPGA 1002 and the engagement member 203 and/or the third port 1008. The logic member(s) 1005 may act as a bridge between processing components and one of the port(s) 1006, 1007, 1008, and the logic member(s) 1005 may provide bidirectional communication, signal conversion, data transmission, data reception, and/or handling of communication protocols as may be understood by those who may have skill in the art.

The processing memory 1009 may be carried by and in communication with the PCB 1018. The processing memory 1009 may also be in communication with the processing member 1001. The processing memory 1009 may include, without limitation, about 4 gigabytes of data storage capabilities and the processing memory 1009 may include its own error correction code (ECC).

The FPGA memory 1010 may be carried by and in communication with the PCB 1018. The FPGA memory 1010 may also be in communication with the FPGA 1002. The FPGA memory 1010 may include, without limitation, 4 gigabytes of data storage capabilities and the FPGA memory 1010 may include its own error correction code (ECC).

The flash memory 1011 may be carried by and in communication with the PCB 1018. The flash memory 1011 may also be in communication with the FPGA 1002. In some embodiments of the present invention, the flash memory 1011 may comprise NOR memory and/or non-volatile flash memory and/or about 4 gigabytes of data storage capabilities.

The second peripheral interface 1013 may include the same and/or similar features, functions, operations, and/or advantageous as the first peripheral interface 1012 discussed herein. The second peripheral interface 1013 may be carried by and in communication with the PCB 1018. The second peripheral interface 1013 may also be in communication with the FPGA 1002. The second peripheral interface 1013 may comprise a quad-serial peripheral interface, and the second peripheral interface 1013 and may be operable to enable data transfer between flash memory and the FPGA 1002. The second peripheral interface 1013 may store firmware, bootloaders, and/or other software components of the computation unit 103 as may be understood by those who may have skill in the art.

The volatile memory 1014 may be caried by and in communication with the PCB 1018. The volatile memory 1014 may also be in communication with the processing member 1001. The volatile memory 1014 may comprise NAND memory, flash memory, about 64 gigabytes of memory, and/or sequential data storage. The volatile memory 1014 may be operable and/or configured to store images, photos, and/or other data received by the volatile memory 1014 and/or computation unit 103 from an auxiliary system 400 that the computation unit 103 is engaged with and/or the auxiliary components 408/payload items 402 of the auxiliary system 400 engaged with the computation unit 103.

Some embodiments of the computation unit 103 may include an I2C driver 1015. The I2C driver 1015 may be utilized by the computation unit 103, the processing member 1001, the FPGA 1002, the communication member 1003, and/or the logic member(s) 1005 to facilitate and/or allow communication therebetween with peripheral devices, such as auxiliary components 408, payload items 402, communication device(s) 414, and/or object(s) 415 via Inter-Integrated Circuit (I2C) protocol as may be understood by those who may have skill in the art.

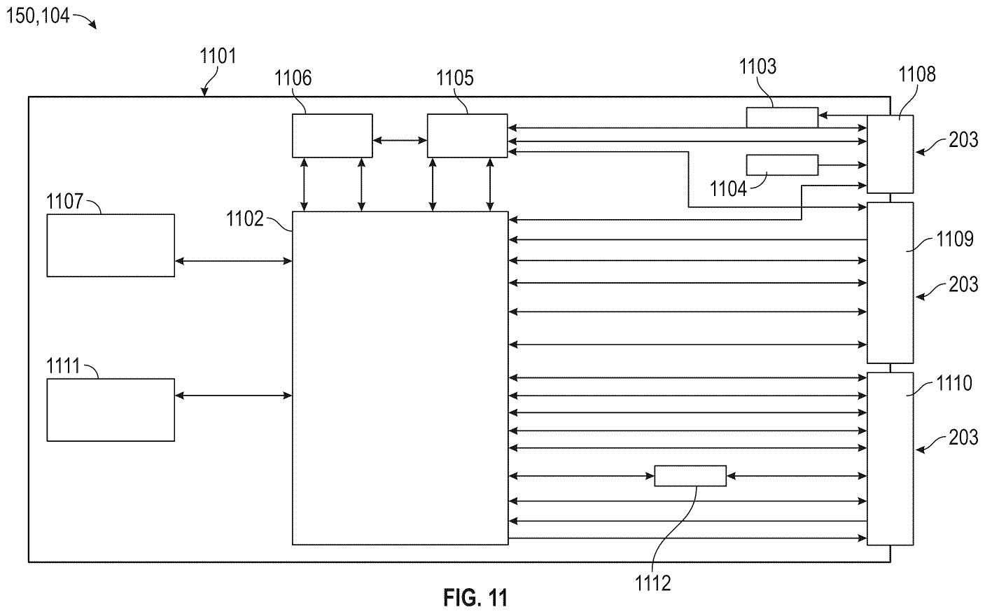

Now referring to FIGS. 6-8 and 11, the data unit 104 may include one or more of a PCB 1101, a processing member 1102, a power member 1103, an auxiliary power member 1104, a first memory 1105, a second memory 1106, a third memory 1107, a peripheral interface member 1111, and/or a logic member 1112. The PCB 1101 may include the same and/or similar features, functions, operations, and/or advantages as one or more of the other PCBs discussed herein. The PCB 1101 may be configured and/or operable to carry one or more components of the data unit 104, and the PCB 1101 may be configured and/or operable to allow and/or facilitate communication between one or more of the components of the data unit 104. The engagement member 203 of the data unit 104 may comprise one or more of a first power 1108, a second port 1109, and/object or area 415 third port 1110.

The engagement member 203 and/or the ports 1108, 1109, 1110 of the data unit 104 may provide, allow, and/or facilitate communications between one or more of the components of the data unit 104 and an auxiliary system 400 when and/or while the data unit 104 is engaged with the auxiliary system 400, and/or the engagement member 203 and/or the ports 1108, 1109, 1110 of the data unit 104 may provide, allow, and/or facilitate communications between one or more of the components of the data unit 104 and one or more of the auxiliary components 408 and/or payload items 402 of and auxiliary system 400 that the data unit 104 may be engaged with.

The processing member 1102 of the data unit 104 may be configured and/or operable to read, write, compute, interpret, identify, execute, exchange, send, receive, transceive, translate, edit, delete, and/or store machine-readable code, data, information, commands, executables, programs, and/or applications. The processing member 1102 may be carried by the PCB 1101, and the processing member 1102 may be in communication with the PCB 1101. The processing member 1102 may also be in communication with one or more of the power member 113, the auxiliary power member 1104, the first memory 1105, the second memory 1106, the third memory 1107, the peripheral interface member 1111, and/or the logic member 1112.

The processing member 1102 may include machine learning software that when and/or while the machine learning software is executed by the processing member 1102, the processing member 1102 may read, interpret, edit and/or parse data, such as image data, and at least one of transform, change, edit, compress, send, and/or store the image data as processed image data. The processing member 1102 may read, interpret, edit and/or parse the image data and transform, change, edit, compress, send, and/or store the image data based on the algorithm of the machine learning software and/or based on historical processed image data, and/or based on selected training processed image data. The processing member 1102 may be configured and/or operable to edit and/or change the algorithm of the machine learning software based on historical processed image data and/or based on the selected training processed image data.

The processing member 1102 may be operable to receive the image data from an auxiliary system 400 and/or from an auxiliary component 408/payload item 402 of and auxiliary system 400 that the data unit 104 may be engaged with. The processed image data may contain an object or area 415 that may be associated with a preselected target object or area 415 that may have been received via a mission plan. The mission plan may be received by the processing member 1102 from a communication device 414, such as, and without limitation, from a communication device 414 comprising a base station, command station, authorized user device, and/or authorized terminal.

The processed image data may be generated and/or provided by the processing member 1102 based on the mission plan, the preselected target object or area 415, the machine learning program, and/or the algorithm of the machine learning program. The processed image data may have a storage space requirement that is significantly smaller than a storage space requirement of the image data used by the processing member 1102 to generate and/or create the processed image data.

The power member 1103 may be carried by the PCB 1101, and the power member 1103 may be in communication with the PCB 1101. The power member 1103 may be configured and/or operable to monitor, manage, provide, and/or facilitate power for the data unit 104 and/or the components of the data unit 104. The power member 1103 may comprise, without limitation, one or more of the power regulator, a voltage regulator, an amperage regulator, a rectifier, an inverter, a battery, a power bank, a power generator, an alternator, solar cells, power cells, and/or photovoltaic device(s) and/or any combination9s) thereof and/or any other power component that may be utilized as the power member 1103 as may be understood by those who may have skill in the art.

The auxiliary power member 1104 may be carried by and in communication with the PCB 1101, and the auxiliary power member 1104 may be in communication with the engagement member 203 of the data unit 104 and/or the first port 1108 of the engagement member 203. The auxiliary power member 1104 may be operable to provide power to at least a portion of an auxiliary system 400 engaged with the data unit 104 and/or engagement member 203 of the data unit 104, and/or the auxiliary power member 1104 may be operable to provide power to one or more auxiliary components 408/payload items 402 of an auxiliary system 400 engaged with the data unit 104 and/or engagement member 203 of the data unit 104.

Embodiments of the data unit 104 may include one or more memory components, such as, and without limitation, one or more of a first memory 1105, a second memory 1106, a third memory 1107, and/or a peripheral interface member 1111. Each memory 1105, 1106, 1107 may be carried by and in communication with the PCB 1101, and each memory 1105, 1106, 1107 may be in communication with the processing member 1102. The first memory 1105 may also be in communication with the second memory 1106, and the communication between the first and second memories 1105, 1106 may comprise an I2C communication protocol.

In some embodiments, both the first and second memories 1105, 1006 may each have two lines of communication with the processing member 1102. The two lines of communication between each of the first and second memories 1105, 1106 and the processing member 1102 may comprise one or more of an I2C communication protocol and/or a universal asynchronous receiver/transmitter (UART) protocol. Also, in some embodiments of the present invention, the second memory 1106 may have a communication line with the processing member 1102 that may comprise a second-generation PCI express (PCI G2) communication line. In some embodiment of the present invention, both the third memory 1107 and the peripheral interface member 1111 may be in communication with the processing member 1102 via fourth generation PCI express (PCIe G4) communication lines. Each of the first, second, and third memories 1105, 1106, 1107 may comprise about four gigabytes of memory storage and double data rate four synchronous dynamic random-access memory (DDR4 SDRAM) memory.

The peripheral interface member 1111 may be carried by the PCB 1102, and the peripheral interface member 1111 may be in communication with the processing member 1102. The peripheral interface member 1111 may comprise a quad-serial peripheral interface, and the peripheral interface member 1111 may be operable to enable data transfer between flash memory and the processing member 1102. The peripheral interface member 1111 may store firmware, bootloaders, and/or other software components of the computation unit 103 as may be understood by those who may have skill in the art. The peripheral interface member 1111 may include the same and/or similar features, functions, operations, and/or advantages as the other peripheral interface member(s) described herein.

The logic member 1112 may be carried by the PCB 1102, and the logic member 1112 may be in communication with one or more of the processing member 1102 and the engagement member 203 and/or the third port 1110. The logic member 1112 may provide and/or facilitate communication between the processing member 1102 and the engagement member 203 and/or third port 1110. The logic member 1112 may act as a bridge between the processing member 1102 and the third port 1110, and the logic member 1112 may provide for bidirectional communication, signal conversion, data transmission, data reception, and/or handling of communication protocols, as may be understood by those who may have skill in the art.

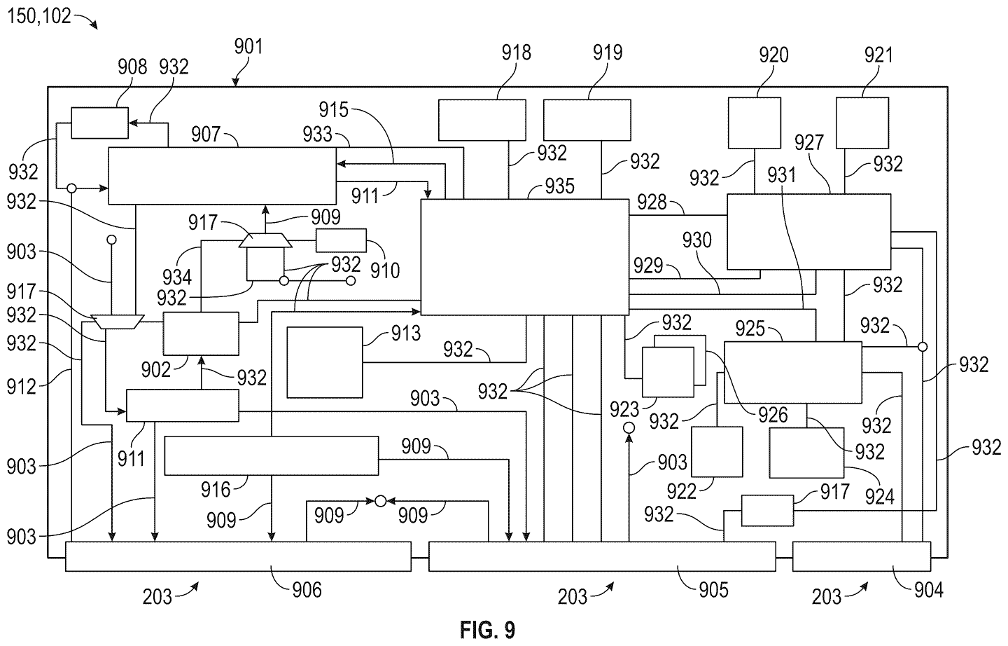

Now referring to FIGS. 9-11, in some embodiments, the PCB 901, 1018, 1101 may comprise of a polycarbonate glass material and/or a mezzanine board that may be flexible. The PCB 901, 1018, 1101 may be radiation hardened, such that, the PCB 901, 1018, 1101 may be configured and/or adapted to be unaffected, significantly unaffected and/or be significantly unchanged when exposed or subjected to radiation, such as, and without limitation, cosmic radiation. Further, the PCB 901, 1018, 1101 may be unaffected, significantly unaffected, and/or significantly unchanged by outgassing. The PCB 901, 1018, 1101 may be configured and/or adapted to be unaffected and/or significantly unaffected while exposed to and/or while having a temperature that is between about −200 degrees Celsius to about +200 degrees Celsius.

The FPGA 927, 1002 may have and/or be radiation hardened. In some embodiments, the FPGA 927, 1002 may support fault mitigation. The FPGA 927, 1002 may further be adapted and/or configured to be reprogrammable, including and without limitation, the FPGA 927, 1002 may be reprogrammable while and/or when an auxiliary system 400 carrying the CDH device 100 is deployed and/or in operation as may be understood by those who may have skill in the art. Some who many have some skill in the art may notice and appreciate that embodiments that include a reprogrammable FPGA 927, 1002 advantageously allows for the FPGA 927, 1002 to provide for later stage tailoring of the FPGA 927, 1002 to one or more selected programs or missions without the need for changing or reconfiguring hardware of most if not all auxiliary systems 400 that may be carrying the CDH device 100 and/or with regards to the hardware of the CDH device 100 itself.

An embodiment of the invention, as shown and described by the various figures and accompanying text, may be directed to a communication device capable of being utilized within a computer system or communication system that is deployed and/or to be deployed in outer space and/or in orbit of a planet, such as, and without limitation, the planet Earth as may be understood by those who may have skill in the art.

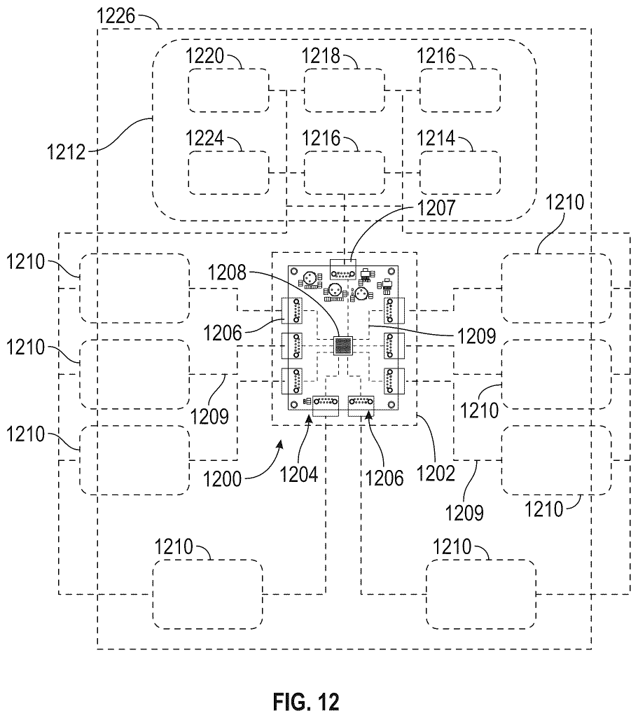

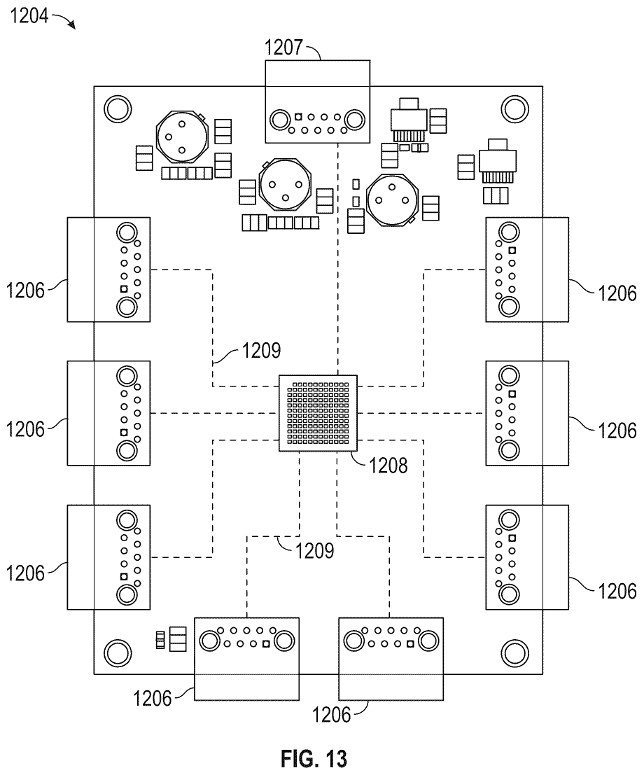

Now referring to FIGS. 12 and 13, some embodiments of the present invention may be directed to and/or include a communication device 1200 that may include a communication hub 1204. The communication device 1200 and/or the communication hub 1204 may be utilized to control, facilitate, allow, monitor, bridge, route, and/or switch communications to, from, and between one or more other devices, such as, and without limitation, communications to, from, and between one or more hardware devices 1210. The communication device 1200 and/or the communication hub 1204 may be operable to control communications to and/or from one or more of the hardware devices 1210 to cause and/or allow one or more of the hardware devices 1210 to send communications to and/or receive communications from one or more of the other hardware devices 1210.

The communication device 1200 and/or the communication hub 1204 may include transceivers 1206 and a transceiver controller 1208. The transceivers 1206 may each be in communication with the transceiver controller 1208. The communication device 1200, the communication hub 1204, and/or one or more of the transceivers 1206 may be connectable, positionable, and/or engageable in communication with one or more hardware devices 1210. For example, without limitation, the communication device 1200/communication hub 1204 may include one or more, and/or the transceivers 1206 may comprise, communication ports that may be selectively connected, positioned, and/or engaged in communication with a compatible communication connector of a hardware device 1210. Moreover, for example, and without limitation the communication ports and/or the communication connectors may comprise, without limitation, one or more of a MIL-spec port/connector, a space-grade D-Sub port/connector, and/or an optical communication port/connector. The MIL-spec port/connector may comprise one or more of a MIL-DTL-38999, a MIL-DTL-5015, a MIL-DTL-28840, a MIL-DTL-24308 (D-Sub), and/or a MIL-DTL-83513 (Micro-D).

Each transceiver 1206 may be positioned in communication with one or more of the other transceivers 1206. The communication between each of the transceivers 1206 may be via the transceiver controller 1208. The transceiver controller 1208 may be operable to manage, control, facilitate, route, bridge, and/or allow the communication between each of the transceivers 1206. Transceiver controller 1208 may be operable to control and manage the communication between each of the transceivers 1206 to route, re-route, bridge, allow, and/or disallow communication between each one of the transceivers 1206, which may be defined as the transceiver controller 1208 controlling the communication between the transceivers 1206. The hardware devices 1210 in communication with one or more of the transceivers 1206 may be in communication with another hardware device 1210 via the transceivers 1206 and the transceiver controller 1208, such that, the communication between the hardware devices 1210 may be controlled by the transceiver controller 1208.

Alternatively, without limitation, the communication hub 1204 may be operable to manage, control, facilitate, route, bridge, and/or allow the communication between each of the hardware devices 1210 that may be in communication with the communication hub 1204. The communication hub 1204 may be operable to control and manage the communication between each of the hardware devices 1210 via the communication hub 1204 to route, re-route, bridge, allow, and/or disallow communication between each one of the hardware devices 1210, which may be defined as the communication hub 1204 controlling the communication between the hardware devices 1210.

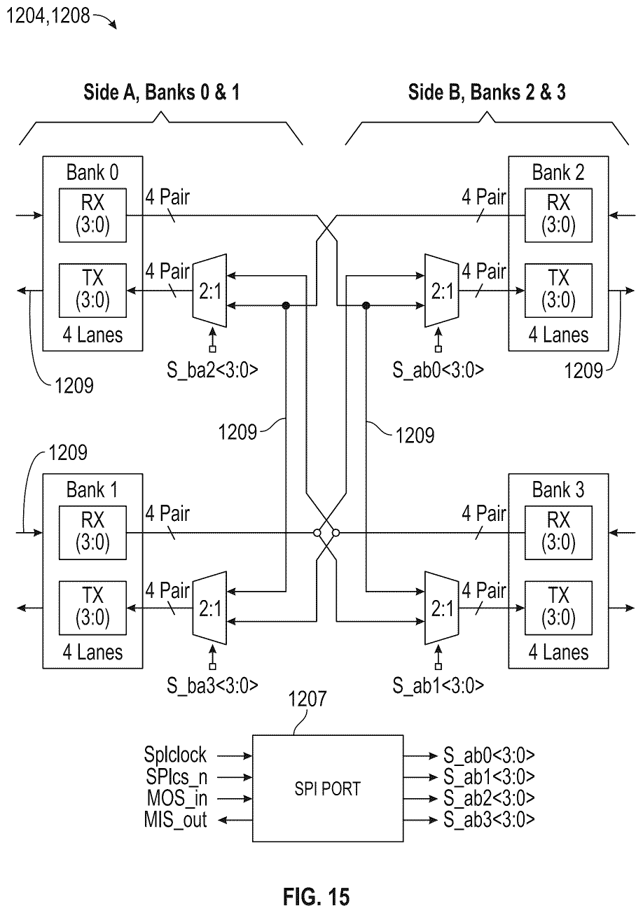

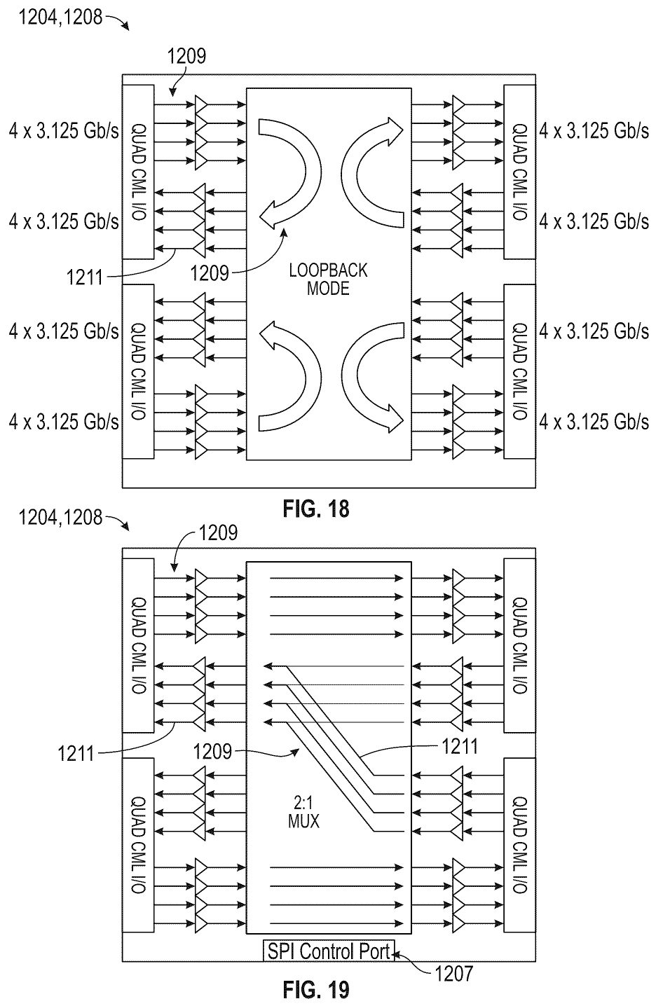

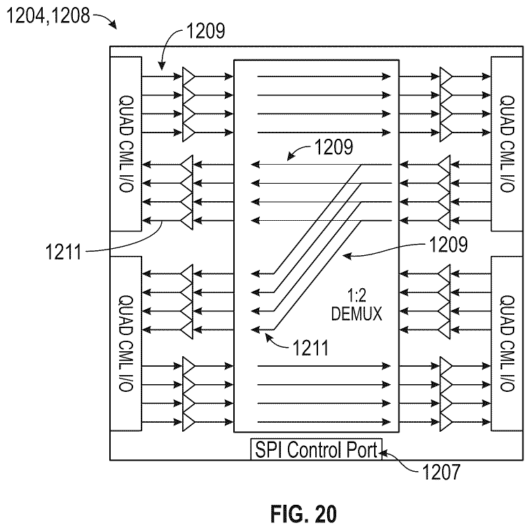

Now referring to FIGS. 13, and 15-20, the communication between the hardware devices 1210 via the transceivers 1206 and the transceiver controller 1208, and/or the communication between the hardware devices 1210 via the communication hub 1204, may be defined as a communication channel between the hardware devices 1210. The transceiver controller 1208 and/or the communication hub 1204 may be operable to maintain and/or change the communication channel. Also, the transceiver controller 1208 and/or the communication hub 1204 may be operable to maintain and/or change the communication channel based upon a control signal. For example, without limitation, the transceiver controller 1208 may be operable to maintain a communication channel so that communication between two or more of the hardware devices 1210 is maintained for the hardware devices 1210 to maintain communications to and/or from one another via the transceiver controller 1208 and via the transceivers 1206 that may be in communication with the one or more hardware devices 1210. For another example, without limitation, the transceiver controller 1208 may be operable to change a communication channel between two or more of the hardware devices 1210 by routing and/or re-routing the communications between two or more of the transceivers 1206 to instead be with one or more other transceivers 1206 so that one or more of the hardware devices 1210 has a communication channel between and with another one or more of hardware devices 1210.

Alternatively, for example, and without limitation, the communication hub 1204 may be operable to maintain a communication channel so that communication between two or more of the hardware devices 1210 is maintained for the hardware devices 1210 to maintain communications to and/or from one another via communication hub 1204. For another example, without limitation, communication hub 1204 may be operable to change a communication channel between two or more of the hardware devices 1210 by routing and/or re-routing the communications between the two or more of the hardware devices 1210 via the communication hub 1204 so that one or more of the two or more hardware devices 1210 has a communication channel changed to be between and with another one or more of hardware devices 1210.

In some embodiments of the present invention, the transceiver controller 1208 may be operable to duplicate communications sent from a hardware device 1210 via one of the transceivers 1206 and to send each of the duplicate communications to two or more other transceivers 1206 so that the communication is received by two or more other hardware devices 1210 that are in communication with the two or more other transceivers 1206, such that a communication channel may be formed that causes the communications sent by one hardware device 1210 is received by two or more other hardware devices 1210. Alternatively, without limitation, the communication hub 1204 may be operable to duplicate communications received from and sent by a hardware device 1210 and to send each of the duplicate communications to a respective two or more other hardware devices 1210 in communication with the communication hub 1204, such that a communication channel may be formed that causes the communications sent by one hardware device 1210 is received by two or more other hardware devices 1210.

In some embodiments of the present invention, the transceiver controller 1208 may be operable to concentrate communications received from two or more hardware devices 1210 via two or more of the transceivers 1206 and to send each of the communications received to only one or more other hardware devices 1210 in communication with one or more other transceivers 1206, such that a communication channel may be formed that causes the communications sent by two or more hardware devices 1210 to be received by only one or more other hardware devices 1210. Alternatively, without limitation, the communication hub 1204 may be operable to concentrate communications received from two or more hardware devices 1210 and to send each of the communications received to only one or more other hardware devices 1210 in communication with the communication hub 1204, such that a communication channel may be formed that causes the communications sent by two or more hardware devices 1210 to be received by only one or more other hardware devices 1210.

In some embodiments of the present invention, the transceiver controller 1208 may be operable to cause communications received from the one or more of transceivers 1206 to be sent back through the same transceiver 1206 from which the communication was received therefrom, such that a communication channel is formed to cause the communications sent by the hardware device(s) 1210 to be looped and sent back to the same hardware device(s) 1210 that originally sent the communication(s). Alternatively, and without limitation, the communication hub 1204 may be operable to cause communications received from the one or more of the hardware devices 1210 to be sent back to the same hardware device 1210 which the communication was received therefrom, such that a communication channel is formed to cause the communications received from one or more hardware device(s) 1210 to be looped and sent back to the same hardware device(s) 1210 that originally sent the communication(s).

For the purposes of the description of the present invention, it should be understood that the transceiver controller 1208 and/or the communication hub 1204 controlling, changing, bridging, routing, and/or re-routing communications and/or a communication channel may also imply that the transceiver controller 1208 and/or the communication hub 1204 is changing and/or removing a portion of and/or all of the original and/or former route of communication and/or the communication channel. For example, without limitation, changing communication and/or a communication channel between a first hardware device 1210/first transceiver 1206 and a second hardware device 1210/second transceiver 1206 for the first hardware device 1210/first transceiver 1206 to be in communication with a third hardware device 1210/third transceiver 1206 and/or form a communication channel between the first hardware device 1210/first transceiver 1206 and the third hardware device 1210/third transceiver 1206 may also include and imply that a portion of or all of the communication and/or communication channel between the first hardware device 1210/first transceiver 1206 and the second hardware device 1210/second transceiver 1206 is changed and/or removed.

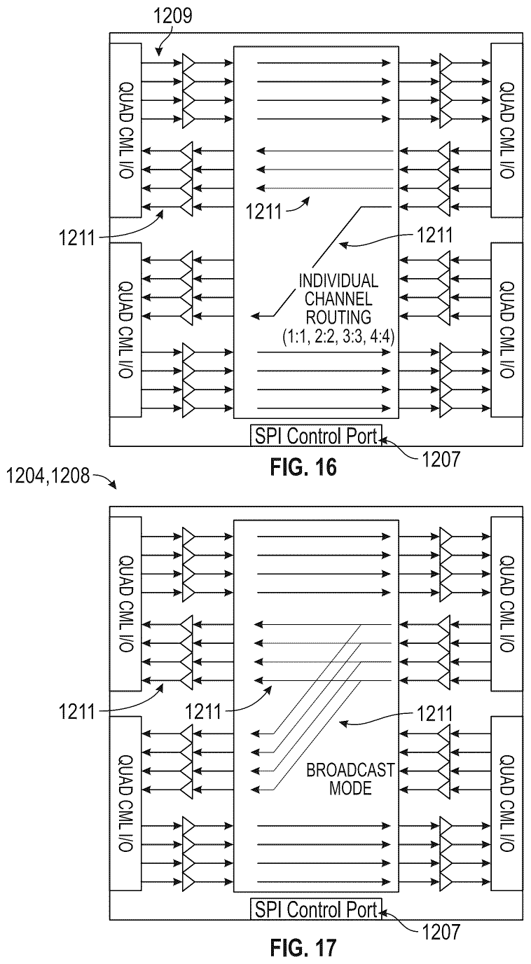

Now referring to FIG. 16 more specifically, in some embodiments of the present invention, a communication channel may comprise multiple individual communication channels that may facilitate and direct communications between two or more hardware devices 1210 and/or between two or more transceivers 1206. The transceiver controller 1208 may be operable to control the communication of the transceivers 1206 and/or control the communication channels to cause one or more of the individual communications channels to be changed, routed, and/or re-routed to another one of the transceivers 1206 and/or to another communication channel. Alternatively, and without limitation, the communication hub 1204 may be operable to control the communication between the hardware devices 1210 and/or the communication channels between two or more hardware devices 1210 to cause one or more of the individual communication channels thereof to be changed, routed, and/or re-routed to another communication channel. For example, without limitation, the transceiver controller 1208 and/or the communication hub 1204 may be operable to change, route, and/or re-route the communication and/or communication channel between a first hardware device 1210 and a second hardware device 1210 to cause one or more of the individual communication channels to be between the first hardware device 1210 and a third hardware device 1210. For another example, without limitation, the transceiver controller 1208 and/or the communication hub 1204 may be operable to change, route, and/or re-route the communication of a first hardware device 1210 to cause one or more individual communication channels to be formed between the first hardware device 1210 and a second hardware device 1210 and cause one or more other individual communication channels to be formed between the first hardware device 1210 and a third hardware device 1210.

The transceiver controller 1208 and/or the communication hub 1204 may be operable to control the communications and/or the communication channels between the transceivers 1206 and/or the hardware devices 1210 based upon a control signal that may be sent by, and received from, a main controller 1212. The main controller 1212 may be in communication with the transceiver controller 1208 and/or the communication hub 1204. The communication hub 1204 may include a controller connector 1207. The controller connector 1207 may be in communication with the transceiver controller 1208 and the main controller 1212, and the main controller 1212 may be in communication with the transceiver controller 1208 via the controller connector 1207.

The transceiver controller 1208 may be operable to create, change, route, and/or re-route one or more of the communication(s), the communication channel(s), and/or the individual communication channels between two or more of the transceivers 1206 and/or two or more of the hardware devices 1210 based upon the control signal. Alternatively, without limitation, the communication hub 1204 may be operable to create, change, route, and/or re-route one or more of the communication(s), the communication channel(s), and/or the individual communication channels between two or more of the hardware devices 1210 based upon the control signal.

For example, without limitation, the transceiver controller 1208, based upon the control signal, may control the communication from and/or to one or more of the transceivers 1206, to and/or from another one or more other transceivers 1206 to cause one or more of the hardware devices 1210 to be in communication with, form a communication channel with, form at least one individual communication channel with, the one or more other hardware devices 1210. For another example, without limitation, the communication hub 1204, based upon the control signal, may control the communication from and/or to one or more of the hardware devices 1210, to and/or from another one or more of the hardware devices 1210, to cause the one or more of the hardware devices 1210 to be in communication with, form a communication channel with, and/or form at least one individual communication channel with, the one or more other hardware devices 1210.

In some embodiments of the present invention, the communication device 1200 and/or the communication hub 1204 may comprise a device board 1203. The device board 1203 may carry one or more of the transceivers 1206, the transceiver controller 1208, and the controller connector 1207. The device board 1203 may facilitate and/or allow communication to, from, and/or between the transceivers 1206, the transceiver controller 1208, and the controller connector 1207. Examples of the device board 1203 include, without limitation, a breakout board, a circuit board, a motherboard, and a printed circuit board. The device board 1203 may be configured to be operable when having a temperature between not less than −55 degrees Celsius and not greater than +105 degrees Celsius. The device board 1203 may comprise a radiation hardened circuit board.

In some embodiments of the present invention, one or more of the hardware devices 1210 may comprise a camera hardware device 1210, and one or more of the hardware devices 1210 may comprise a framegrabber hardware device 1210. The transceiver controller 1208 and/or the communication hub 1204 may be operable to control communication between and/or form a communication channel between multiple camera hardware devices 1210 and the framegrabber hardware devices 1210 so that multiple camera hardware devices 1210 may be in communication with a shared framegrabber hardware device 1210. For example, without limitation, the transceiver controller 1208 and/or the communication hub 1204 may be operable to control and/or route communications of two camera hardware devices 1210 so that the two camera hardware devices 1210 are in communication with a single framegrabber hardware device 1210 to cause the data emitted and/or sent by each of the two camera hardware devices 1210 is received by the single framegrabber hardware device 1210.

Those skilled in the art may notice and appreciate that typically each camera hardware device 1210 would require its own dedicated framegrabber hardware device 1210 to receive and process the data from the camera hardware device 1210, but however, by utilizing an embodiment of the present invention, only one framegrabber hardware device 1210 may be required to receive and process the data from multiple camera hardware devices 1210. The data received and processed by the framegrabber hardware device 1210 may then be sent to the main controller 1212 and/or the processor unit 1216 of a satellite 1226, 1212. Those skilled in the art may also notice and appreciate that satellites that incorporate an embodiment of the present invention to centralize, manage, and control communications between hardware devices 1210 of a satellite also reduces the chance and risk of communication conflicts between hardware devices 1210 and between hardware devices 1210 and the main controller 1212 and/or the processor unit 1216 of the satellite 1226, 1212.

However, it is contemplated that the embodiments of the present invention are not limited to only being utilized to allow multiple camera hardware devices 1210 to communicatively operate with one or more shared framegrabber hardware devices 1210, and that the embodiments of the present invention may be applied to allow other hardware devices 1210 to communicatively operate with other hardware devices 1210 typically associated with those other hardware devices 1210. Especially in order to reduce the number of the associated hardware devices 1210 required to facilitate the operations of the other hardware devices 1210 by controlling and managing the communications therebetween with an embodiment of the present invention.

The communication device 1200 and/or the communication hub 1204 may be configured and/or adapted to be utilized within a spacecraft and/or an orbital device. For example, the communication device 1200 may be configured and/or adapted to be utilized with a satellite, as may be understood by those who may have skill in the art. The communication device 1200, communication hub 1204, and/or the transceiver controller 1208 may be configured to have a redundant and cross strapped serial data path that may be within and/or compliant with the VITA78 Space VPX standard for data plane switch functions. For example, without limitation, the satellite may comprise a main controller 1212, a housing body 1226, a power unit 1214, a processor unit 1216, a communication unit 1218, a bus unit 1220, a datastore unit 1222, and a memory unit 1224. The communication device 1200 may be carried by the housing body 1226 and may be in communication with one or more of the main controller 1212, the power unit 1214, the processor unit 1216, the communication unit 1218, the bus unit 1220, the datastore unit 1222, the memory unit 1224, and in communication with one or more hardware devices 1210 carried by the housing body 1226.

Embodiments of the present invention may include firmware stored in the datastore unit 1222 and/or the memory unit 1224 of the main controller 1212. The main controller 1212 may be operable to register a user input made associated with the hardware devices 1210 in communication with the communication hub 1204 and/or the transceivers 1206. Based upon the user input, the main controller 1212 may send a control signal to the communication hub 1204, transceiver controller 1208, and/or the controller connector 1207 associated with the user input. Based upon this control signal, the communication hub 1204 and/or the transceiver controller 1208 may control the communication and/or the communication channels 1209, 1211 of the hardware devices 1210 and/or of the transceivers 1206.

In some embodiments of the present invention, each hardware device 1210 may also be in communication with the main controller 1224 and/or the processor unit 1216. The hardware devices 1210 may be operable to send an identification signal to the main controller 1212 and/or the processor unit 1216 that may be associated with the hardware device 1210 which sent the identification signal. Based upon the identification signal, the main controller 1212 may send a control signal to the communication hub 1204, transceiver controller 1208, and/or the controller connector 1207. Based upon this control signal, the communication hub 1204 and/or the transceiver controller 1208 may control the communication and/or the communication channels 1209, 1211 of the hardware devices 1210 and/or of the transceivers 1206.

In some embodiments of the present invention, the hardware devices 1210 may be operable to send an identification signal to the communication hub 1204 and/or the transceiver controller 1208. The communication hub 1204 and/or the transceiver controller 1208 may be operable to generate a control signal based upon the identification signals received from each of the hardware devices 1210. Based upon this control signal, the communication hub 1204 and/or the transceiver controller 1208 may control the communication and/or the communication channels 1209, 1211 of the hardware devices 1210 and/or of the transceivers 1206.

Examples of the communication hub 1204 include, without limitation, a high-speed switch card, a low voltage differential signaling (LCDS) switch card, and a port replicator. Examples of the transceiver controller 1208 include, without limitation, a protocol independent crosspoint switch, such as, and without limitation, a Frontgate™ protocol independent crosspoint switch such as the Frontgate™ UT65CML8X8FD 3.125 Gbps crosspoint switch. The transceiver controller 1208 may comprise an 8×8 full duplex crosspoint switch matrix, and may have data rates up to 3.125 giga-bits per second (Gbps) per channel. The transceiver controller 1208 may be protocol independent, and the transceiver controller 1208 may have a low latency and a low channel-to-channel skew. The transceiver controller 1208 may include a serial peripheral control (SPI) port control interface. The transceiver controller 1208 may have low power dissipation, and may have separate power domains per bank.

The transceiver controller 1208 may be operable to power down communication channels that are not in use to save power, and the transceiver controller 1208 may be operable to detect loss of signal (LOS) in each of the communication channels. The transceiver controller 1208 may also include 50 Ohm high-speed terminations as may be understood by those who may have skill in the art. The transceiver controller 1208 and/or the communication hub 1204 may be configured to be operable when having a temperature between not lower than −55 degrees Celsius and not greater than +105 degrees Celsius. The transceiver controller 1208, the communication hub 1204, and the communication device 1200 may also be radiation hardened to withstand total doses that are not greater than 5000 rads. The transceiver controller 1208, the communication hub 1204, and/pr the communication device 1200 may be substantially immune to single-event latchups (SEL) that are not greater than 1200 MeV*cm² per milligram. The transceiver controller 1208, the communication hub 1204, and/or the communication device 1200 may have a SET-BER of 7×10-17 errors/dev-day.

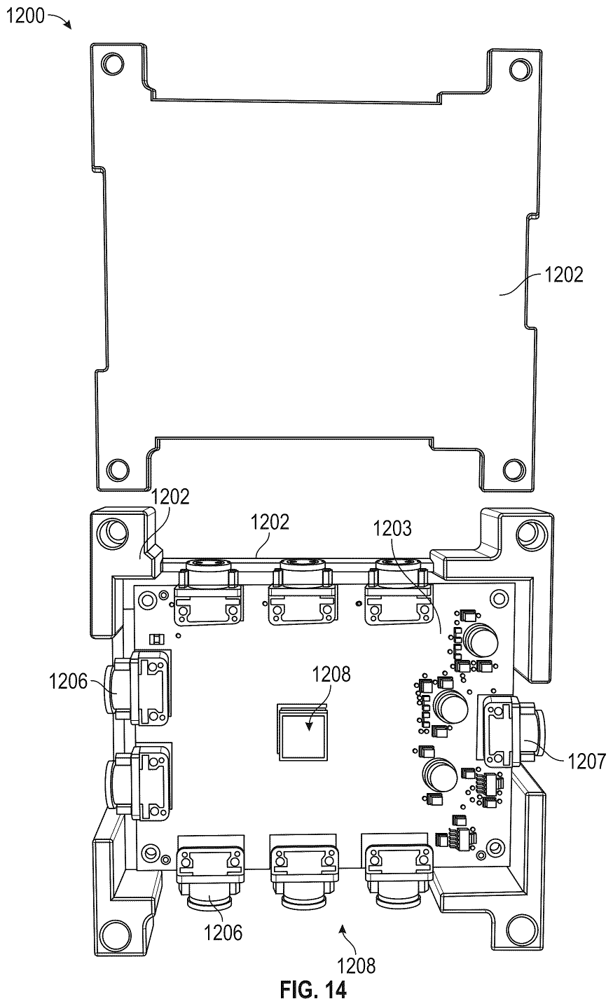

Now referring to FIG. 14, the communication device 1200 may include a housing 1202. The communication hub 1204 may be carried by the housing 1202. The housing 1202 may be configured to be substantially structurally unchanged when exposed to extreme temperatures. The housing 1202 may comprise a 3D printed material, such as, without limitation, 3D printed composite by continuous fused fiber fabrication with onyx composite filament. The housing 1202 may be adapted to be fixed to a surface or object and to be carried by a housing body 1226 of a satellite.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A device for data handling and communication comprising:
a housing; and
a communication hub carried by the housing and comprising:
a main controller;
a transceiver controller in communication with the main controller; and
a plurality of transceivers positioned in communication with the transceiver controller and positionable in communication with a respective plurality of hardware devices;
wherein the transceiver controller is operable to control communication between each one of the plurality of transceivers to selectively route and bridge communication between each of the respective plurality of hardware devices;
wherein the main controller is operable to generate and send a control signal to the transceiver controller; and
wherein the transceiver controller selectively routes and bridges communication between each of the respective plurality of hardware devices by controlling communication between the plurality of transceivers based on the control signal; and
wherein the housing comprises a radiation hardened housing;
wherein the communication hub is configured to withstand radiation doses that are not greater than 5000 radiation absorbed dose (“rads”);
wherein the communication hub is configured to withstand Single-Event Latchups (“SEL”) that are not greater than 100 MeV*cm2 per milligram;
wherein the communication hub has a Single-Event Transient Bit Error Rate (“SET-BER”) of 7×(10\hat{ }(−17)) errors per day; and
wherein the communication hub is operable in temperatures between −55 degrees Celsius and +105 degrees Celsius.

2. The device of claim 1, wherein the transceiver controller is operable to selectively route and bridge the communication between the plurality of transceivers to cause the signals transmitted from the respective plurality of hardware devices to be received by at least another one of the respective plurality of hardware devices.

3. The device of claim 1, wherein the transceiver controller is operable to selectively route and bridge the communication between the plurality of transceivers to cause signals transmitted from one of the respective plurality of hardware devices to be received by at least two of the respective plurality of hardware devices.

4. The device of claim 1, wherein the transceiver controller is operable to selectively route and bridge the communication between the plurality of transceivers to cause signals transmitted from at least two of the respective plurality of hardware devices to be received by one of the respective plurality of hardware devices.

5. The device of claim 1, wherein each one of the plurality of transceivers includes a plurality of communication channels.

6. The device of claim 5, wherein the plurality of communication channels includes receiver communication channels and transmission communication channels.

7. The device of claim 1, wherein the housing comprises a composite 3D printed continuous fused fiber fabrication providing using onyx composite filament.

8. The device of claim 1, wherein the plurality of transceivers include at least one communication port that comprises at least one of a space-grade D-Sub port, an optical communication port, and a MIL-spec port; and wherein the MIL-spec port includes at least one of a MIL-DTL-38999 port, a MIL-DTL-5015 port, a MIL-DTL-28840 port, a MIL-DTL-24308 (D-Sub) port, and a MIL-DTL-83513 (Micro-D) port.

9. The device of claim 1, wherein the respective plurality of hardware devices comprise a plurality of camera devices and at least one framegrabber hardware device in communication with the plurality of transceivers; and wherein the transceiver controller controls communication between the plurality of transceivers to route and bridge communication between the plurality of camera devices and the at least one framegrabber hardware device.

10. The device of claim 9, wherein the at least one framegrabber hardware device is operable to be in communication with more than one camera device of the plurality of camera devices.

11. The device of claim 10, wherein the plurality of camera devices generate and emit camera data signals; wherein the transceiver controller controls communication between the plurality of transceivers to cause the camera data signals to be received by the at least one framegrabber hardware device; wherein the at least one framegrabber hardware device processes the camera data signals to generate and emit processed camera data; and wherein the transceiver controller controls communication between the plurality of transceivers to cause the processed camera data signals to be received by the main controller.

12. The device of claim 1, wherein each of the plurality of transceivers comprises a plurality of communication channels.

13. The device of claim 12, wherein the transceiver controller is operable to cause 50 Ohm high-speed terminations at each of the plurality of communication channels.

14. The device of claim 12, wherein the transceiver controller is operable to detect loss of signal (“LOS”) at each of the plurality of communication channels.

15. The device of claim 1, wherein the transceiver controller comprises a protocol independent crosspoint switch.
